(19) United States
(12) Patent Application Publication
(10) Pub. No.: US 2007/0168853 A1
(43) Pub. Date: Jul. 19, 2007

(54) APPARATUS, SYSTEM AND METHOD FOR CREATION, DELIVERY AND UTILIZATION OF RECOMMENDED MULTIMEDIA FILTER SETTINGS

(76) Inventor: Matthew T. Jarman, Salt Lake City, UT (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/620,039

(22) Filed: Jan. 4, 2007

Related U.S. Application Data
(60) Provisional application No. 60/756,905, filed on Jan. 5, 2006.

(51) Int. Cl. G06F 17/00; G06F 3/00

(52) U.S. Cl. 715/500.1; 715/530; 715/732

(57) ABSTRACT

An apparatus, such as a DVD player, system (client-server, etc.) and method for creating and deploying recommended filter arrangements for a multimedia presentation, such as a movie set forth on a DVD type optical disc. The recommended filter arrangements are selected from some number of possible filter arrangements for a particular multimedia presentation. The recommended filters settings are stored in the memory of the DVD player, in one particular example. During play of the multimedia presentation, the recommended filters are assessed and appropriate filtering action is taken, such as skipping, muting, cropping, blurring, and beeping, certain portions of the multimedia with content involving violence, sex and nudity, profanity, as well as other forms of content objectionable to some audiences.

### CROSS REFERENCE TO RELATED APPLICATION

The present application is a non-provisional application claiming priority under 35 U.S.C. § 119(e) to co-pending U.S. provisional application No. 60/756,905 titled “Apparatus, System, and Method for Creation, Delivery and Utilization of Recommended Filter Settings,” which is hereby incorporated by reference herein.

### FIELD OF THE INVENTION

Aspects of the present invention involve a system, method, and apparatus for creation, delivery and utilization of recommended multimedia filter settings.

### BACKGROUND

A multimedia presentation, such as audio provided on CD and a movie provided on DVD, may contain certain language, images, scenes, or other content, not suitable or considered objectionable by certain audiences. To address this concern certain technologies have been developed to allow filtering of various types of content. One such filtering technology is a media player, such as a personal computer or DVD player, configured to allow filtered playback of a movie or other multimedia presentation as described in U.S. patent application Ser. No. 11/104,924 titled “Apparatus, System, and Method for Filtering Objectionable Portions of Multimedia Presentation,” filed on Apr. 12, 2005 (the '924 application), which is hereby incorporated by reference herein. Generally, in a DVD filtering environment there can be several different possible filtering options. For example, a user can elect to filter certain content (e.g., turn off audio and/or not show certain scenes) based on whether the content includes profanity, violence, sex, nudity, drug use, etc. With a wide variety of different filter options, there is a corresponding wide variety of different playback scenarios for any given multimedia presentation. For example, with 14 different filter types that may be activated or deactivated in any combination, there are potentially 16,384 playback configurations. With such a wide variety of filtering options and playback configurations, it can be difficult for a user to know which of the many playback configurations will filter the content they want filtered, but also present the multimedia in an entertaining and coherent manner.

### SUMMARY

One aspect of the present invention involves a method for presenting multimedia that comprises accessing a multimedia presentation and accessing a recommended subset of a plurality of filters for the multimedia, the plurality of filters configured to alter the presentation of the multimedia presentation. Then, applying the recommended subset of the plurality of the filters to alter the presentation of the multimedia presentation.

Another aspect of the present invention involves a media player that comprises a memory arrangement storing a plurality of filters for a multimedia presentation, the memory further storing a recommendation of a subset of the plurality of filters to apply to the multimedia presentation to alter the presentation of the multimedia presentation. The media player also includes at least one processor configured to apply the subset of the plurality of filters to the multimedia player. One example of a media player that may be configured to conform with aspects of the present invention is a DVD player.

Another aspect of the present invention involves a computer program product including a recommended multimedia filter arrangement. The computer program product includes a computer useable medium and computer readable code embodied on the computer useable medium for one or more filter files associated with the multimedia presentation, the filter files each identifying a portion of the multimedia presentation, each filter file further identifying a filtering action for the portion of the multimedia presentation. The computer code also includes an indication of a pre-established subset of the plurality of filter files to be applied to a multimedia presentation to alter presentation of the multimedia presentation.

Finally, another aspect of the present invention involves a method of generating a recommended filter selection for a multimedia presentation. The method involves evaluating a plurality of filters for a multimedia presentation against a criteria, the plurality of filters configured to alter the presentation of the multimedia presentation. The method further involves providing a recommended subset of the plurality of filters as a function of the operation of evaluating the plurality of filters against a criteria.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a flowchart illustrating one method for establishing recommended filter settings in conformance with aspects of the present invention.

FIG. 2A is an on-screen menu illustrating violence filter setting selections;

FIG. 2B is an on-screen menu illustrating recommended violence filter setting selections;

FIG. 3 is an on-screen menu allowing a user to alter recommended filter settings;

FIG. 4 is a block diagram illustrating filtered playback according to recommended filter settings;

FIG. 5 is a diagram illustrating a case where particular portions of a presentation may have more than one possible filtering action; and

FIG. 6 is an on-screen menu providing a user with options for choosing different possible filter actions.

### DETAILED DESCRIPTION OF EMBODIMENTS

Aspects of the present invention involve methods, systems, apparatus, and computer program products for automatically identifying and filtering portions of multimedia content. Aspects of the present invention further involve providing a recommended filter setting or settings that a user may select or which may be preset. The recommended filter setting automatically activates or deactivates certain combinations of individual filter types. Such a recommended filter setting may apply to a subgrouping of filter types, e.g., all violence related filters, or may apply to individual filter types.

A broad aspect of the invention involves filtering one or more portions of a multimedia presentation. Filtering may involve muting objectionable language in a multimedia presentation, skipping past objectionable portions of a multimedia presentation, modifying the presentation of a video image such as through cropping or fading some portion of the image, or otherwise modifying presentation of the multimedia presentation to eliminate, reduce, or modify the objectionable or unwanted language, images, or other content. Filtering may further extend to other content that may be provided in a multimedia presentation, including close captioning text, data links, program guide information, etc.

By way of example, various recommended filter settings embodiments are described herein with reference to the filtering technology set forth in the '924 application. However, recommended filter settings, preset filter combinations, and other aspects of assisting a user in selecting application of filter types to apply to a particular multimedia presentation, type of multimedia presentation, etc., generally referred to herein as recommended filter settings or the like, are not limited to application in a platform conforming to the '924 application. Rather, recommended filter settings are applicable to any platform that allows or facilitates filtering or otherwise modifying play of a movie or otherwise presentation of any form of multimedia.

With respect particularly to DVD-based audiovisual presentations, such as video, typically, a DVD can hold a full-length film with up to 133 minutes of high quality audio and video compressed in accordance with a Moving Picture Experts Group (“MPEG”) coding formats. One advantage of the particular filtering platform described in the '924 application, is that it does not require any modification or alteration of the formatting of the presentation in order for filtering to occur. Stated another way, to perform filtering, the presentation need not be preformatted and stored on the DVD with any particular separate information related to the language or type of images being delivered at any point in the presentation. Rather, filtering involves monitoring existing time codes of multimedia data read from the DVD or closely tracking the timing of the presentation. As described in greater detail below, a filter file or event includes a time code corresponding to a portion of the multimedia data that is intended to be skipped or muted. A match between a time code of a portion of the multimedia presentation read from a DVD with a time code in the filter file, causes the execution of a filtering action, such as a mute or a skip. It is also possible to monitor other indicia of the multimedia data read from the DVD, such as indicia of the physical location on a memory media from which the data was read.

Until the mute, time seek (skip) or other filtering action is executed, the DVD player reads the multimedia information from the DVD during conventional sequential play of the multimedia presentation. Thus, the operations associated with a play command on the DVD are executed. The play command causes the read-write head to sequentially read portions of the video from the DVD. As used herein, the term “sequential” is meant to refer to the order of data that corresponds to the order of a multimedia presentation. The multimedia data, however, may be physically located on a memory media in a non-sequential manner. Moreover, MPEG coding may involve non-linear access to certain types of data for proper decoding and display. Typically, the multimedia information read from the DVD is stored in a buffer. From the buffer, the MPEG coded multimedia information is decoded prior to display on a monitor, television, or the like. The buffer allows the system to maintain a fairly constant decoding rate so that the presentation of the movie is not negatively affected from processing, or retrieval, or other latencies. A buffer may not be necessary depending on the retrieval speed, decoding speed, and other factors.

In one aspect, the time code for the multimedia information read from a memory media and stored in a memory buffer is compared to filter files in a filter table. A filter table is a collection of one or more filter files, also referred to as a filter or event, for a particular multimedia presentation. A filter file is an identification of a portion of a multimedia presentation and a corresponding filtering action. Each filter file may be identified by or otherwise associated with one or more filter types, such as Strong Action Violence or Brutal/Gory violence filter types. The portion of the multimedia presentation may be identified by a start (or interrupt) and end time (or resume code), by start and end physical locations on a memory media, by a time or location and an offset value (time, distance, physical location, or a combination thereof, etc.). Within a filter table for a particular presentation, a user may activate any combination of filter files or no filter files. For example, for the film “Gladiator,” the Strong Action Violence filter may be deactivated and the Brutal/Gory Violence filter activated. Thus, some or all portions of the movie associated with a Strong Action Violence filter type will be shown while some or all portions of the movie associated with a Brutal/Gory violence filter type will be skipped or otherwise filtered.

Table 1 below provides two examples of filter files for the movie “Gladiator”. The filter types set forth in Table 1 are similar, but not the same, as other examples of filter types set forth herein. As discussed herein, a collection of filter files for any particular multimedia presentation is stored together in a filter table. A filter table for a particular multimedia presentation may be provided as a separate computer file on a removable memory media, in the same memory media as the multimedia presentation, on separate memory media, or otherwise loaded into the memory of a multimedia player configured to operate in accordance with aspects of the invention.

TABLE 1
Filter Table with example of two Filter Files for the Film Gladiator

| Filter | Start | End | | Filter | Filter Codes |
|---|---|---|---|---|---|
| (Event) | (Interrupt) | (Resume) | Duration | Action | (Types) |
| 1 | 00:04:15:19 | 00:04:48:26 | 997 | Skip | 2: V-D-D, |
| | | | | | V-D-G |
| 2 | 00:04:51:26 | 00:04:58:26 | 210 | Skip | 1: V-D-G |

Referring to Table 1, the first filter file (1) has a start time of 00:04:15:19 (hour:minute:second:frame) and an end time of 00:04:48:26. The first filter file further has a duration of 997 frames and is a “skip” type filtering action (as opposed to a mute or other action). Finally, the first filter file is associated with two filter types. The first filter type is identified as “V-D-D”, which is a filter code for a violent (V) scene in which a dead (D) or decomposed (D) body is shown. The second filter type is identified as “V-D-G”, which is a filter code for a violent (V) scene associated with disturbing (D) and/or gruesome (G) imagery and/or dialogue. Implementations of the present invention may include numerous other filter types. During filtered playback of the film “Gladiator,” if the “V-D-D”, “V-D-G,” or both filter files are activated, the 997 frames falling between 00:04:15:19 and 00:04:48:26 are skipped (not shown). Additionally, if the V-D-G filter file is activated, the 210 frames falling between 00:04:51:26 and 00:04:58:26 are skipped.

Table 2 below provides one example of various possible filter types conforming to one particular embodiment of the present invention. Other filter types, quantities of filter types, etc., may be implemented in various embodiments conforming to aspects of the present invention.

TABLE 2
Filter Types and Associated
Description of Content of Scene for each Filter Type

| Filter | Filter | | |
|---|---|---|---|
| Code | Classification | Filter type | Filter Action |
| V-S-A | Violence | Strong Action Violence | Removes excessive violence, |
| | | | including fantasy violence |
| V-B-G | Violence | Brutal/Gory Violence | Removes brutal and graphic |
| | | | violence scenes |
| V-D-I | Violence | Disturbing Images | Removes gruesome and other |
| | | | disturbing images |
| S-S-C | Sex and | Sensual Content | Removes highly suggestive and |
| | Nudity | | provocative situations and |
| | | | dialogue |
| S-C-S | Sex and | Crude Sexual Content | Removes crude sexual language |
| | Nudity | | and gestures |
| S-N | Sex and | Nudity | Removes nudity, including partial |
| | Nudity | | and art nudity |
| S-E-S | Sex and | Explicit Sexual Situation | Removes explicit sexual dialogue, |
| | Nudity | | sound and actions |
| L-V-D | Language | Vain Reference to Deity | Removes vain or irreverent |
| | | | reference to Deity |
| L-C-L | Language | Crude Language and Humor | Removes crude sexual language |
| | | | and gestures |
| L-E-S | Language | Ethnic and Social Slurs | Removes ethnically or socially |
| | | | offensive results |
| L-C | Language | Cursing | Removes profane uses of “h*ll” |
| | | | and “d*mn” |
| L-S-P | Language | Strong Profanity | Removes swear words, including |
| | | | strong profanities |
| L-G-V | Language | Graphic Vulgarity | Removes graphic vulgarities, |
| | | | including “f***” |
| O-E-D | Other | Explicit Drug Use | Removes descriptive scenes of |
| | | | illegal drug use |

Table 2 provides a list of examples of filter types that may be provided individually or in combination in an embodiment conforming to the invention. The filter types are grouped into five broad classifications, including: Violence, Sex/Nudity, Language, and Other. Within each of the four broad classifications, are a listing of particular filter types associated with each broad classification. As described further below, it is possible to establish recommended filter settings of the basis of the classification, e.g., all language filter types are activated, and on the basis of individual filter types, e.g., only the strong profanity and graphic vulgarity filter types are activated. In a filter table for a particular multimedia presentation, various time sequences (between a start time and an end time) of a multimedia presentation may be identified as containing subject matter falling within one or more of the filter types. In one particular implementation, multimedia time sequences may be skipped or muted as a function of a particular filter type, e.g., V-S-A. Alternatively, or additionally, multimedia time sequences may be skipped or muted as a function of a broad classification, e.g., V, in which case all portions of a multimedia presentation falling within a broad filter classification will be skipped or muted.

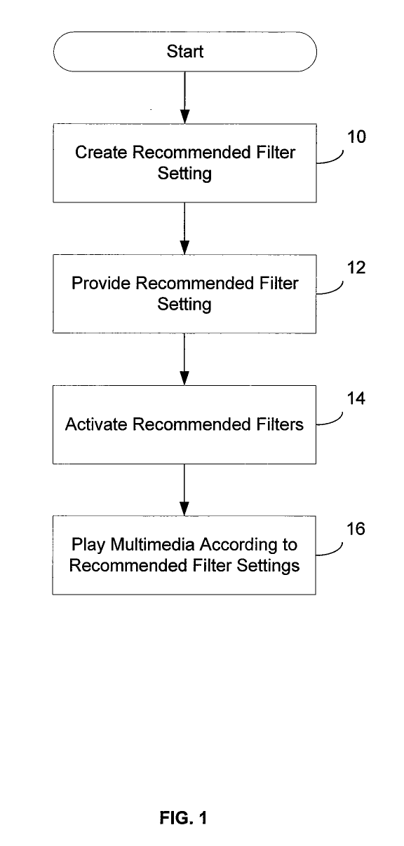

FIG. 1 is a flowchart illustrating an overall flow of events involving the generation and play of a multimedia presentation according to recommended filter settings (operation 10). First, a recommended filter setting is created. Creation or definition of a recommended filter setting or settings may be performed from a computer implemented method or may be manually generated. There are numerous basis on which to create recommended filter settings. For example, recommended filter settings may be made globally, on a genre basis, on a specific movie or other specific multimedia title basis, on an actor, director, studio, or producer basis, on a date basis, on a viewer basis, and to effectively change a conventional rating for a particular movie title. Further, recommended filter settings may apply to a subgrouping of all filter types or may apply to all available filters.

Recommended filter settings, in one particular implementation, apply to the filter files in a filter table for a particular multimedia presentation. For example, the filter table for the movie Gladiator may contain some total number of filter files, say 400, corresponding with 400 portions of the film that involve scenes or other content falling within one or more of the various filter types set forth in Table 2. After application of the recommended filter settings, unless all filter types are activated, some number less than 400 filter files will be activated. It is also possible to create custom filter files for a particular movie such that the recommended filter settings do not activate or deactivate filter files in filter table, but rather a custom filter table is generated with active filter files.

In the example of a recommended filter setting for a particular movie title, such as Gladiator, manual definition of recommended filter settings, whether applicable to a subgrouping of filter types or all filter types, may involve a certain level of creativity and subjective decisions. Computer implemented definition of recommended filter settings involves an objective result. In either case, the basis for the recommended filter settings may take into account any possible factor or combination of factors. For example, recommended filter settings for a particular movie title may be defined with the knowledge that the film is largely sexual in nature, including numerous scenes with sensual content, crude sexual content, nudity, and explicit sexual situations. A person aware of the strong sexual nature of the film will make subjective decision as to which of the sex and nudity type filters to activate that will not be objectionable to a typical person not wanting to be generally exposed to sex and nudity while still presenting the movie in an entertaining and coherent manner. The generation of recommended filter settings may be undertaken in an iterative manner, with a user activating and deactivating certain filter combinations, watching the movie, and finally settling on a particular combination of active and deactivated filter setting of an overall recommended filter setting for the movie.

With the same movie of a strong sexual nature, or any other movie, algorithmically, recommended filter settings may be made based on any number of factors. For example, a computer may analyze the filter table (filter files) for a particular movie title to determine the number and/or length (time) of each instance of a particular type of filter. Based on this determination, recommended filter settings may be automatically generated. For example, in a movie containing 20 instances of sensual content, five instances of crude sexual content, 30 instances of nudity, and four instances of explicit sexual situations, a computer may establish recommended filter settings by application of thresholds. An example of thresholds within sex and nudity filter grouping might include: sensual content filter “on” (active) if less than 10 instances, crude sexual content filter “on” if less than 10 instances, nudity filter “on” if less than 10 instances, and explicit sexual situation filter “on” if less than 10 instances. Applying these thresholds to the above example movie, the recommended filter settings will include deactivating the sensual content and nudity filters (each have less than 10 instances) and activating the crude sexual content and explicit sexual situations filters (each have greater than 10 instances) by application of thresholds.

As set forth above, numerous different methodologies and approaches may be employed to define recommended filters settings. Additionally, as introduced above, recommended filters settings may be defined on various basis, of which the following examples are not exhaustive. First, a global recommended filter setting applies at any time filtered playback is selected, irrespective of the particular multimedia title. For example, in a DVD player configured to allow filtered play of movies on DVD, when filtering is activated, the recommended filter settings will be applied to any DVD movie being played, irrespective of the particular movie title. Thus, Gladiator will be played with the same filter settings as The Matrix or Sleepless in Seattle.

Second, genre based recommended filter settings will apply to any multimedia title of a particular genre. For example, a recommended filter setting may be available for sci-fi movies, action movies, G, PG, PG-13, R, NR, and X movies, etc. The various recommended filter settings may be the same or different, but are nonetheless selected based on the genre. In such an instance, the genre for any particular multimedia title is either identified automatically or by way of user input. Automatic genre definition may be achieved by comparing identifying indicia, such as a DVD movie title, encoded MPAA rating information, etc., to a look-up table stored or otherwise loaded to the media player, the table mapping or otherwise relating particular multimedia titles to a genre. It is also possible for a user to manually select a genre recommended filter setting to apply to a different genre; thus, for example, a user may choose to apply the recommended filter settings for an action movie to a sci-fi movie.

Third, as more fully described below, recommended filter settings may be applied on a movie by movie basis. Thus, each movie or other multimedia title has its own recommended filters settings. Table 3 set forth below is one example of recommended filter settings for the movie Gladiator.

TABLE 3
Example of Recommended Filter Settings

| Filter | | Recommended |
|---|---|---|
| Classification | Filter type | Filter Setting |
| Violence | Strong Action Violence | OFF |
| Violence | Brutal/Gory Violence | ON |
| Violence | Disturbing Images | ON |
| Sex and | Sensual Content | OFF |
| Nudity | | |
| Sex and | Crude Sexual Content | ON |
| Nudity | | |
| Sex and | Nudity | OFF |
| Nudity | | |
| Sex and | Explicit Sexual Situation | ON |
| Nudity | | |
| Language | Vain Reference to Deity | ON |
| Language | Crude Language | ON |
| | and Humor | |
| Language | Ethnic and Social Slurs | ON |
| Language | Cursing | OFF |
| Language | Strong Profanity | ON |
| Language | Graphic Vulgarity | ON |
| Other | Explicit Drug Use | ON |

Fourth, recommended filter settings may be applied on the basis of some aspect of a movie besides its rating or title, such as actors, directors, studio producing the film, producers, date of the film, etc., Fifth, recommended filter settings may be employed to effectively change the MPAA or other conventional rating for a film. Thus, applying one set of recommended filters might be effective to alter play of an R-rated film to conform to PG rating standards. Rating altering filter settings may be unique to particular movie, or may be generalized to apply to all movies or sub-groupings of movies. Finally, recommended filter settings may be established on a user basis. Such user specific recommended filter settings would be useful for a parent to establish a filter setting for a child. User specific filter settings might also be coordinated with a user/password log-in requirement such that the child must log-in to the system to watch a movie and the preestablished recommended filter settings will automatically apply.

Referring again to FIG. 1, after generation of one or more recommended filter settings, a file or other form of data arrangement for the recommended filter settings is stored in a player, such as a DVD player, configured for filtered play or otherwise delivered to the end user for storing or otherwise configuring the player (operation 12). In one example, recommended filter settings may be delivered in paper form, via email, or in other form intended for a user to manually enter the recommended filter settings. In another example, recommended filter settings may be available (viewable) on a network site, such as a website on the Internet, and the user simply visits the site to view the recommended filter settings. Referring to Table 3, the recommended filter settings for the movie Gladiator may be provided in paper form, in an email, or on a network site. The user then manually activates or deactivates individual filter types according to the recommendation in a manner as discussed in the '924 application.

In another implementation, a playback device may come preprogrammed with some or all recommended filter settings. Additionally or alternatively, recommended filter settings may be loaded into playback device memory by way of some removable memory medium, by way of a network medium, or other electronic means. For example, a DVD, memory stick, or other removable memory media containing recommended filter settings, which may also contain one or more filter files, is placed in communication with the playback device, such as by placing the DVD into a DVD drive or plugging the memory stick into a USB port, at which time the playback device determines that the memory media contains recommended filter settings and uploads the settings to device memory. In another example, a user may access a network site, such as a website accessible on the Internet, and download recommended filter settings. Network access may be achieved directly from a playback device, or a separate device, such as a personal computer, may be used to connect with a network site. In the case of a separate device accessing the network site, the recommended filter setting file or files are stored to a removable memory media, which may then be used to load the recommended filter setting files to the playback device.

U.S. Provisional Patent Application No. 60/641,678 titled “Video Player Configured to Receive Playback Filters from Alternative Storage Mediums,” filed on Jan. 5, 2005, and related non-provisional application no. 11,327,103 titled “Media Player Configured to Receive Playback Filters from Alternative Storage Mediums” filed on Jan. 5, 2006, which are each hereby incorporated by reference herein, describes various ways to transfer filter files to a playback device by way of a removable memory media. This platform may also be used with slight modification to load recommended filter settings to a playback device. U.S. patent application Ser. No. 11/256,419 titled “Method and User Interface for Downloading Audio and Video Content Filters to a Media Player,” filed on Oct. 20, 2005, which is hereby incorporated by reference herein, describes various ways to transfer filter files to a playback device by way of a network connection. This platform may also be used with slight modification to load recommended filter settings to a playback device.

Referring again to FIG. 1, after recommended filter settings are available in playback device memory, a user may activate the recommended filter settings (operation 14). Such activation may occur in various ways, including activation on a movie-by-movie basis, i.e., a user chooses whether to employ recommended filter settings each time a movie or other multimedia is played, on a global basis, i.e., every time multimedia is played irrespective of the multimedia, or on a semi-global basis, i.e., every time some specified form of multimedia is played. For example, in the system described in the '924 application, when a user chooses to proceed with filter playback, the user is provided with one or more on-screen menus that allow the user to activate or deactivate the available filters. In an implementation according to the present invention, the user may be provided with an additional option to activate recommended filter settings. The recommended filter settings option may provide the user with any number of options depending on the particular recommended filter setting implementation. For example, if recommended filter settings are available on a movie-by-movie basis, then the user will be provided the option to view and/or activate the recommended filter settings for a particular movie, provided the playback device has a file or is otherwise provided with the recommended filter settings. Alternatively, when the user is presented with the screen allowing the user to activate or deactivate particular filter files, the screen will have certain filters activated or deactivate (selected) according to the recommended settings, the user then may change the recommendations or simply proceed with play according to the recommended settings.

In another alternative, if some form of global or semi-global recommended filter settings are available, then the user may be provided with the opportunity to either activate or deactivate the global settings.

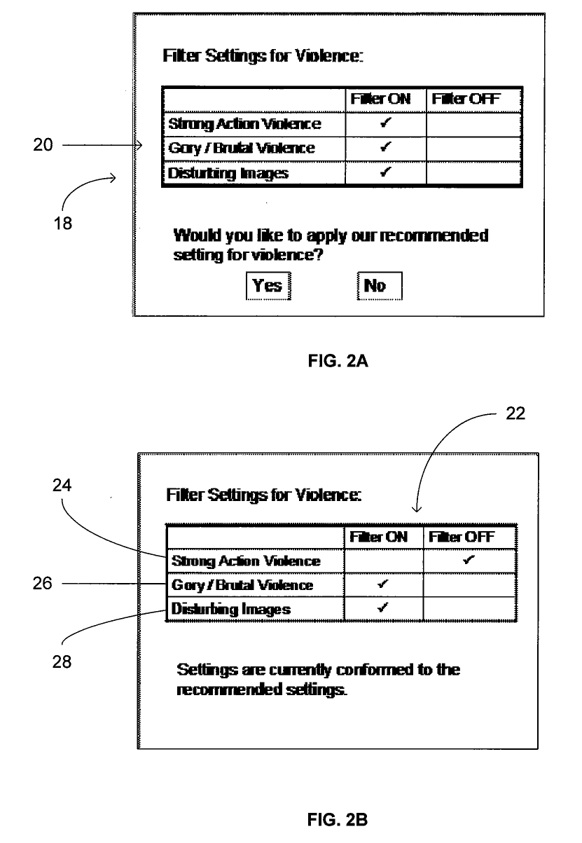

FIG. 2A illustrates one example of an on-screen menu 18 used to activate or deactivate violence filter settings for a particular movie. In this example, all of the violence filter types 20 are activated. At the bottom of the screen, the user is prompted as to whether they would like to apply the recommended violence filter settings for this particular movie. By selecting “Yes,” the filter settings 22 are altered as shown in FIG. 2B. In this example, the Strong Action Violence filter 24 is turned off (deactivated), while the Gory/Brutal Violence and Disturbing Images violence filters remain activated. Thus, during playback any portion of the movie associated with the Gory/Brutal Violence 26 or Disturbing Images 28 filter types will be skipped, while portions of the movie associated with Strong Action Violence will be shown.

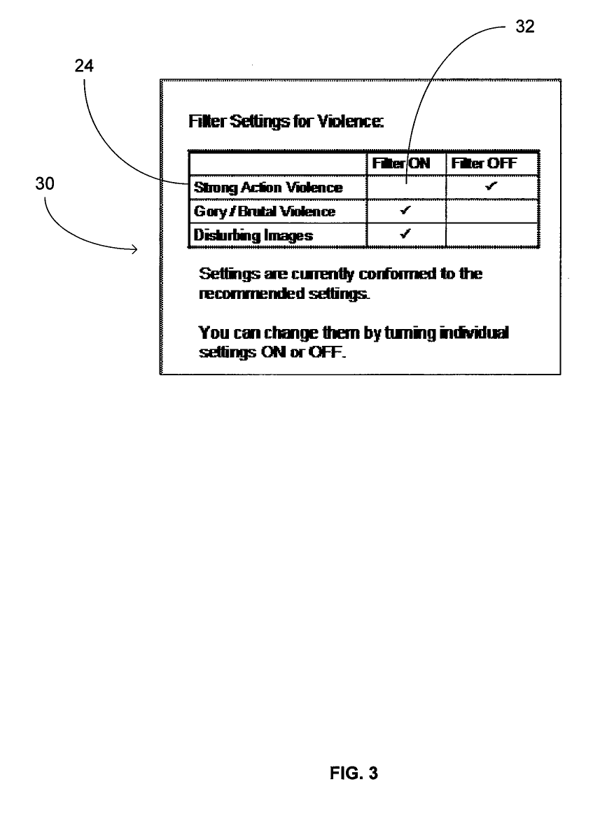

FIG. 3 illustrates an on-screen menu allowing a user to alter recommended filter settings. In this example, the recommended violence filter type settings are shown, which may be on any of the basis set forth herein. The user may alter the recommended filter settings by selecting the appropriate box. For example, to activate the Strong Action Violence filter type, the user clicks on the “Filter ON” box 32 for the filter type. With a television, set-top box, or other similar media player arrangement employing a remote control, the user manipulates and on-screen prompt by way of arrow keys, and depresses the enter button when the appropriate selection box is highlighted.

If the user selects some form of recommended filter setting, and the recommended filter setting is not available, then the user may be provided with on-screen menus directing the user to obtain the recommended filter settings in one or more of the various ways discussed herein.

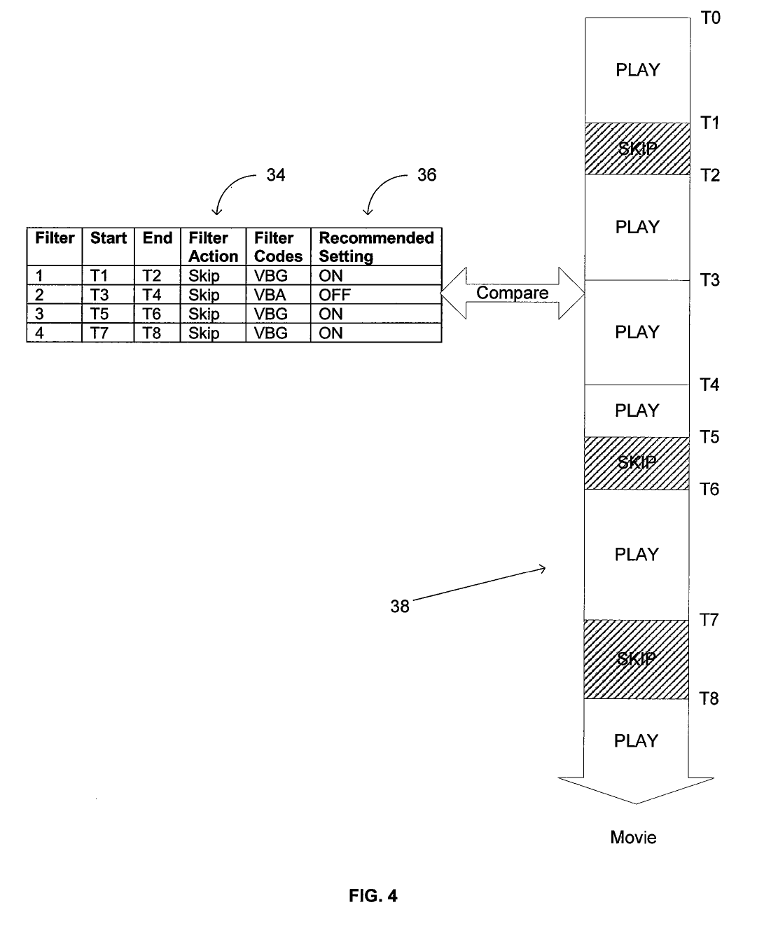

Referring again to FIG. 1, recommended filter playback proceeds with application recommended filter activations causing skipping, muting, or other alteration of portions of a multimedia presentation corresponding to activated filter types (operation 16). FIG. 4 illustrates a filter table 34 with recommended filter settings 36 and a block diagram of a movie 38 showing time frames relating to portions of the movie corresponding to the illustrated filter types. The table shows four filters, 1-4, corresponding to time frames T1-T2, T3-T4, T5-T6, and T7-T8, respectively. Filter files 1 and 3-4 are Brutal/Gory Violence filter types, and filter file 2 is a Strong Action Violence filter type. Thus, the portion of the movie between times 1-2, 5-6, and 7-8 have Brutal/Gory Violence, while the portion of the movie between times 3 and 4 has Strong Action Violence. Filtered play with the recommended filter settings will have normal playback (unaltered) between the start of the movie (T0) to T1, the portion of the movie between T1 and T2 will be skipped, normal play will resume at T2 and continue to T5(note, the portion of the movie between T3 and T4 is not skipped because the Strong Action Violence filter is not activated), the portion of the movie between T5 and T6 will be skipped, normal play will resume at T6 and continue to T7, the portion of the movie between T7 and T8 will be skipped, and normal play will resume at T8. In one particular implementation, a “time skip” or similar action is taken by a DVD player to execute the skip operation.

Recommended filter settings for a particular media presentation may be generated in various ways as set forth above. In an additional alternative method, recommended filter settings may be generated with a tool that aggregates user feedback of recommended filter settings. For example, after watching a movie with filtering, a user can fill out a form with their recommended settings, access a web site with a recommended filter settings template, email filter recommendations, provide filter recommendations in a web blog format, or otherwise provide some indication of their recommended filter settings for a particular movie. It is further possible to qualify recommendations, e.g., “I recommend settings X for overall enjoyment of the movie,” “I recommend settings Y for children,” or “We watched the movie with settings Z and it was too choppy,” etc.,

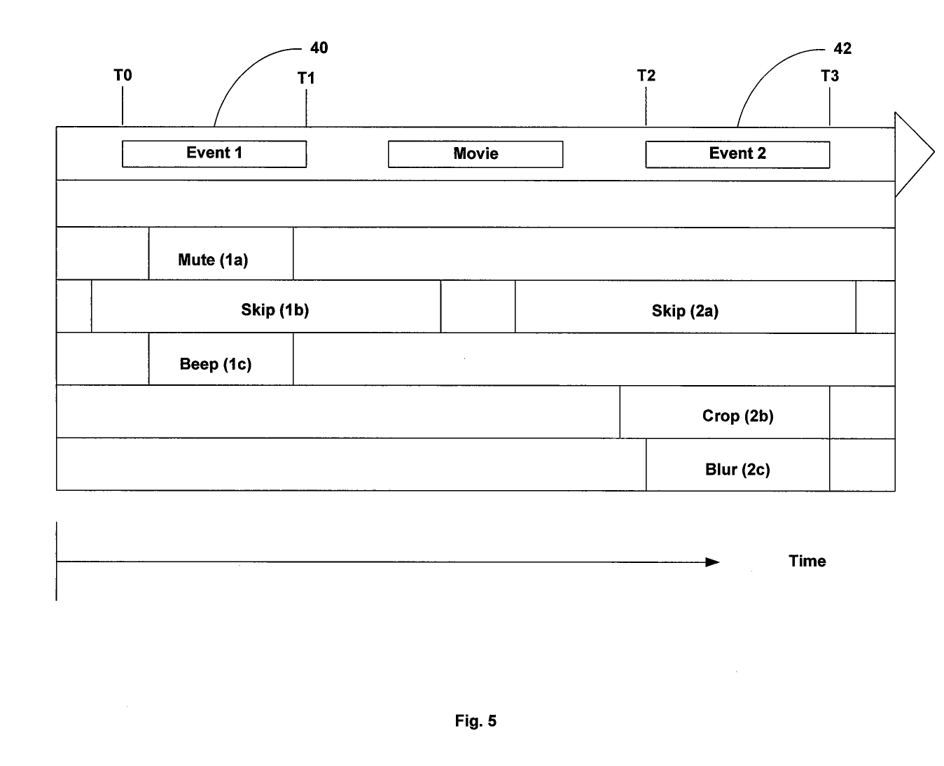

In some implementations, there can be instances where more then one type of filter method is associated with the same portion of multimedia. In the example set forth in FIG. 5, there are two portions of the multimedia content that are filterable—event 1 (40) and event 2 (42), which are set out at some times T₀ to T₁ and T₂ to T₃, respectively. There are different filtering methods for the content in event 1 and event 2. First, filtering event 1 may involve muting the audio, skipping both video and audio, and covering the audio with a beep. Table 4 provides an example of each filter type associate with the first event, e.g., portion of a movie subject to filtering. Table 4 also provides start and end times for each filter type, similar but possibly more or less than the time span between T₀ to T₁.

TABLE 4

| Event | | | |
|---|---|---|---|
| Type | Start | End | Classification |
| Mute | 00:10:15 | 00:11:00 | Profanity |
| Skip | 00:10:00 | 00:15:00 | Profanity |
| Beep | 00:10:15 | 00:11:00 | Profanity |

Second, filtering event 2 may involve skipping both the video and audio, cropping the picture so that some visual content is no longer viewable, or blurring the picture so that some or all visual content is no longer recognizable. Table 5 provides an example of each filter type associate with the second event. Again, Table 5 also provides start and end times for each filter type, similar but possibly more or less than the time span between T₂ to T₃. In both cases, the time spans are defined to encompass the content meant to filtered, whether profanity, violence, or others.

TABLE 5

| Event | | | |
|---|---|---|---|
| Type | Start | End | Classification |
| Skip | 00:20:00 | 00:25:00 | Violence |
| Crop | 00:23:00 | 00:25:00 | Violence |
| Blur | 00:24:00 | 00:25:00 | Violence |

These different types of filtering methods provide different options for the end-user. For example, to filter profanity an end-user may prefer to mute the audio rather then skipping ahead in both the audio and video. Alternatively, an end—user may prefer that if there is ever an option to either mute the audio or skip ahead in the movie to always skip ahead. Similarly, to filter violence an end-user may prefer to blur the video or some portion of the video, rather than skipping ahead or cropping the image. Alternatively, an end-user may prefer that if there is ever an option to either skip ahead in the movie or crop, to always crop. These alternative settings may be implemented on a filter by filter type basis, or as part of recommended filter settings.

In yet another alternative, the user to rely on recommend a type of filtering on an event by event basis. For example, for event 1, there may be a recommendation of “muting” and for event 2 there may be a recommendation of “cropping” the picture.

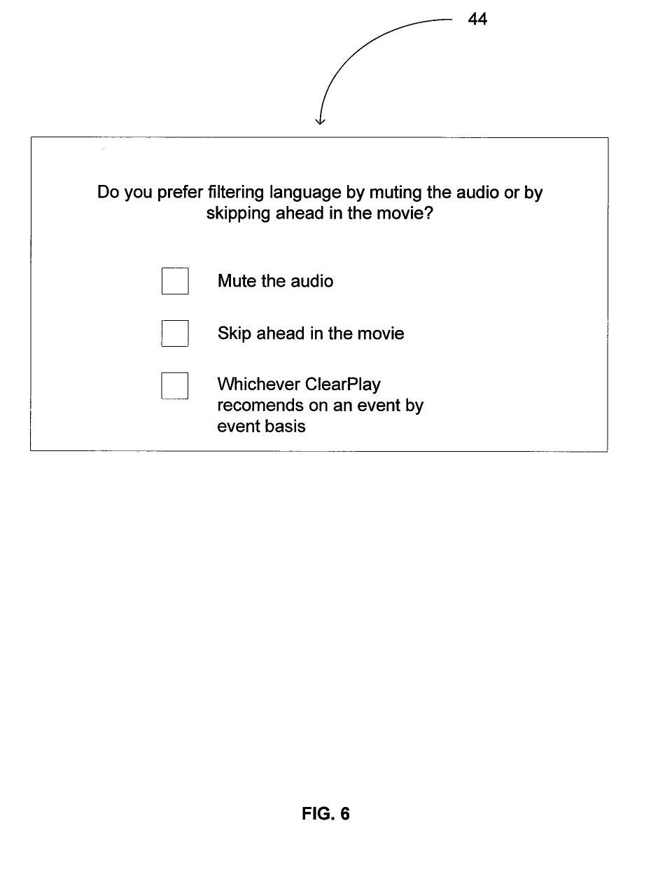

FIG. 6 is a screen shot of an example of a menu 44 to facilitate user selection of recommended filter settings when there are various possible filtering actions set forth with any particular filter type or portion of a media presentation. In one example, when recommended filter settings are defined, a flag may be provided next to the recommend filtering method for each event. Table 6 provides one example of setting a recommendation for event 1 described above with reference to Table 4. In this example, skipping is recommended over muting or beeping. If the user were to select the recommended settings, then the portion of the media between the start and end would be skipped.

TABLE 6

| Recommended | | | | |
|---|---|---|---|---|
| Method? | Event Type | Start | End | Classification |
| No | Mute | 00:10:15 | 00:11:00 | Profanity |
| Yes | Skip | 00:10:00 | 00:15:00 | Profanity |
| No | Beep | 00:10:15 | 00:11:00 | Profanity |

Finally, it may be advantageous to add a grouping value with each event, so that only one filtering method is triggered per event, as set forth below in Table 7.

TABLE 7

| Event | Recommended | Event | | | |
|---|---|---|---|---|---|
| Group | Method? | Type | Start | End | Classification |
| 1 | No | Mute | 00:10:15 | 00:11:00 | Profanity |
| 1 | Yes | Skip | 00:10:00 | 00:15:00 | Profanity |
| 1 | No | Beep | 00:10:15 | 00:11:00 | Profanity |
| 2 | No | Skip | 00:20:00 | 00:25:00 | Violence |
| 2 | Yes | Crop | 00:23:00 | 00:25:00 | Violence |
| 2 | No | Blur | 00:24:00 | 00:25:00 | Violence |

In a further alternative implementation, although there can be several filtering methods, some playback devices may only support a sub-set of the different filtering methods. For example, DVD player X may support muting, skipping, and beeping, while DVD player Y only supports muting and skipping. For each event, as set forth in an example of Table 8, the different filtering methods could be ranked in order of recommendation.

TABLE 8

| Recommended | | | | |
|---|---|---|---|---|
| Method Ranking | Event Type | Start | End | Classification |
| 2 | Mute | 00:10:15 | 00:11:00 | Profanity |
| 3 | Skip | 00:10:00 | 00:15:00 | Profanity |
| 1 | Beep | 00:10:15 | 00:11:00 | Profanity |

For player X, when a user selects to filter according to recommendations, the player will use beep filtering method for this event (because the beep method is supported on this player and the beep method is the 1st recommended method for this event). For player Y, on the other hand, when the user selects to filter according to recommendations, the player will use a mute filtering method (because the beep method is not supported on this player, but the mute method is supported, and the mute method is the 2nd recommended method for this event)

Blurring an image or series of images may be achieved in various ways. In one example, a certain area of an image or the entire image is identified as including some form of objectionable material. For example, a series of images of a video may show a graphic wound. This portion of the image, by x and y coordinates defining a square or rectangular area for example, is identified and the area within the portion of the image is blurred. Blurring of the image may be performed by converting color pixel values to black and white, remove brightness information, reassigning pixel values within the area to an average of all of the pixel values, or otherwise modifying the pixel value information within the area effective to modify, distort, or otherwise blur the objectionable portion of the image while leaving the remaining portion of the image the same.

Disclosed herein are various aspects of a media player and related method for providing recommended filter settings, playing media according to recommended filter settings, and other aspects involving filter recommendations. While the disclosed embodiments are described in specific terms, other embodiments encompassing principles of the invention are also possible. Also, while specific examples of menus presented to the user have been provided, many other ways of presenting the same or related information may be employed to the same end. Further, while specific examples particularly discuss a DVD player, other types of media players capable of displaying movies and other media presentations, may also be utilized within the scope of the invention.

Throughout the application, reference is made to integrated local filter storage memory of the media player. While such memory is ordinarily thought of as memory permanently installed on a printed circuit board of the player, a removable storage media may also be used to store the filters employed by the player. For example, memory sticks, USB sticks, removable flash memory, and the like, connectable to a removable storage media reader of the player accessible by the user, may be employed to similar end. As a result, the removable storage medium may be coupled with a home computer of the user. The user may then download the filters over the Internet from the filter provider, storing those filters into the removable storage medium. The medium could then be removed from the home computer, and connected to the media player by way of the removable interface of the player designed for the medium, such as a USB port. The player could then access the filters for use in filtering the content of the DVDs associated with those filters. It is also possible to obtain the removable memory media containing filter information by other means, such as mail order, from a movie outlet, or on the same memory as the media.

Further, operations and menus are presented in one particular order. The order, however, is but one example of the way that operations and menus may be provided. Operations and menus may be rearranged, modified, or eliminated in any particular implementation while still conforming to aspects of the invention.

The present invention extends to methods, systems, and computer program products for automatically identifying and filtering portions of multimedia content during the decoding process. A media player conforming to aspects of the present invention may include a special purpose or general purpose computer including various computer hardware, a television system, an audio system, and/or combinations of the foregoing. In all cases, the described embodiments should be viewed as exemplary of the present invention rather than as limiting it's scope.

Embodiments within the scope of the present invention also include computer readable media for carrying or having computer-executable instructions or data structures stored thereon. Such computer-readable media may be any available media that can be accessed by a general purpose or special purpose computer. By way of example, and not limitation, such computer-readable media can comprise RAM, ROM, EEPROM, DVD, CD ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications link or connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

I claim:

1. A method for presenting multimedia comprising:
accessing a multimedia presentation;
accessing a recommended subset of a plurality of filters for the multimedia, the plurality of filters configured to alter the presentation of the multimedia presentation; and
applying the recommended subset of the plurality of the filters to alter the presentation of the multimedia presentation.

2. The method of claim 1 wherein the multimedia presentation comprises a movie provided on an optical disc.

3. The method of claim 1 wherein each of the plurality of filters identifies a portion of the multimedia presentation, each filter further identifying a filtering action for the portion of the multimedia presentation.

4. The method of claim 3 wherein the filtering action is selected from the group comprising skipping, muting, blurring, cropping, and beeping.

5. The method of claim 3 wherein at least one of the plurality of filters identifies a plurality of filter actions, the method of further comprising:
applying the recommended subset of the plurality of the filters to alter the presentation of the movie, wherein the recommended subset includes a recommendation of one of the plurality of filtering actions.

6. The method of claim 1 wherein the plurality of filters are configured to alter the presentation of the multimedia content for portions of the multimedia involving violence, sex and nudity, and explicit language.

7. The method of claim 1 wherein the operation of accessing a recommended subset of the plurality of the filters for the multimedia presentation further comprises:
obtaining an identifier associated with the multimedia presentation; and
selecting a particular recommended subset of the plurality of filters based on the identifier.

8. The method of claim 7 wherein the identifier is selected from the group comprising genre, MPAA rating, title, actor, director, studio, producer, and date of multimedia presentation.

9. The method of claim 1 further comprising:
identifying an MPAA rating for the multimedia presentation; and
applying the recommended subset of the plurality of the filters to alter the presentation of the multimedia presentation such that the MPAA rating of the multimedia presentation is changed.

10. The method of claim 1 further comprising:
identifying a user; and
applying the recommended subset of the plurality of the filters to alter the presentation of the multimedia presentation as a function of the user identification.

11. A media player comprising:
a memory arrangement storing a plurality of filters for a multimedia presentation, the memory further storing a recommendation of a subset of the plurality of filters to apply to the multimedia presentation to alter the presentation of the multimedia presentation; and
at least one processor configured to apply the subset of the plurality of filters to the multimedia player.

12. The media player of claim 11 wherein the at least one processor is configured to automatically apply the recommended filter setting.

13. The media player of claim 11 further comprising:
a look-up table stored in the memory wherein the look-up table includes an identifier for a plurality of multimedia presentations; and
wherein a particular recommended filters setting is applied to the multimedia presentation to alter playback, the application being a function of the identifier.

14. The media player of claim 13 wherein the identifier is selected from the group comprising genre, MPAA rating, title, actor, director, studio, producer, and date of multimedia presentation.

15. The media player of claim 11 further comprising at least one communication interface adapted to receive a recommended filter from an external source.

16. The media player of claim 15 wherein the at least one communication interface is selected from the group comprising a network interface, a removable memory interface, and a USB port.

17. The media player of claim 11 further comprising:
an optical disc reader operably coupled with the at least one processor.

18. The media player of claim 11 further comprising:
an MPEG decoder operably coupled with the at least one processor.

19. A computer program product including a recommended multimedia filter arrangement comprising:
a computer useable medium and computer readable code embodied on the computer useable medium comprising:
one or more filter files associated with the multimedia presentation, the filter files each identifying a portion of the multimedia presentation, each filter file further identifying a filtering action for the portion of the multimedia presentation; and
an indication of a pre-established subset of the plurality of filter files to be applied to a multimedia presentation to alter presentation of the multimedia presentation.

20. The recommended multimedia filter arrangement of claim 19 further comprising:
a media player including a memory storing the multimedia filter arrangement.

21. The recommended multimedia filter arrangement of claim 19 further comprising:
a server including a memory storing the multimedia filter arrangement.

22. A method of generating a recommended filter selection for a multimedia presentation comprising:
evaluating a plurality of filters for a multimedia presentation against a criteria, the plurality of filters configured to alter the presentation of the multimedia presentation; and
providing a recommended subset of the plurality of filters as a function of the operation of evaluating the plurality of filters against a criteria.

23. The method of claim 22 wherein each of the plurality of filters identifies a portion of the multimedia presentation and at least one type of content associated with the portion of the multimedia presentation, each filter file further identifying a filtering action for the portion of the multimedia presentation, the operation of evaluating the plurality of filters against a criteria further comprising:
identifying a number of filters with a common type of content;
comparing the number of filters against a threshold; and
identifying the number of filters as a recommended filter if the number of filters meets the threshold.

24. The method of claim 22 wherein the criteria comprises user feedback.

25. The method of claim 22 wherein each of the plurality of filters identifies a portion of the multimedia presentation, each filter further identifying a plurality of filtering actions for the portion of the multimedia presentation.

26. The method of claim 22 further comprising ranking each of the plurality of filtering actions.
